(19) United States
(12) Patent Application Publication
(10) Pub. No.: US 2024/0359166 A1
(43) Pub. Date: Oct. 31, 2024

(54) LOW-TEMPERATURE NITROGEN OXIDE ADSORBER BASED ON METAL OXIDE-SUPPORTED PLATINUM/GAMMA-ALUMINA CATALYST AND METHOD FOR PREPARING SAME

(71) Applicant: KOREA UNIVERSITY RESEARCH AND BUSINESS FOUNDATION, Seoul (KR)

(72) Inventors: Ki Bong LEE, Seoul (KR); Kwan Young LEE, Seoul (KR); Hyun Wook KIM, Seongnam-si (KR)

(73) Assignee: KOREA UNIVERSITY RESEARCH AND BUSINESS FOUNDATION, Seoul (KR)

(21) Appl. No.: 18/682,704

(22) PCT Filed: Feb. 8, 2022
(86) PCT No.: PCT/KR2022/001905

§ 371 Date: Feb. 9, 2024

(30) Foreign Application Priority Data
Aug. 11, 2021 (KR) 10-2021-0105845

(51) Int. Cl. B01J 23/89; B01D 53/94; B01J 21/04; B01J 23/42; B01J 23/63; B01J 35/30; B01J 35/61; B01J 35/63; B01J 37/02; B01J 37/08

(52) U.S. Cl. CPC B01J 23/894; B01D 53/9413; B01J 21/04; B01J 23/42; B01J 23/63; B01J 23/8926; B01J 35/394; B01J 35/615; B01J 35/635; B01J 37/0205; B01J 37/0236; B01J 37/024; B01J 37/08; B01D 2255/1021; B01D 2255/2065; B01D 2255/20761; B01D 2255/9207; B01D 2257/404; B01D 2258/012

(57) ABSTRACT

The present invention discloses a low-temperature nitrogen oxide adsorber based on a metal oxide-impregnated platinum/gamma-alumina catalyst and a method for preparing the same. According to the present invention, the present invention provides a method for preparing a passive nitrogen oxide adsorber for removing nitrogen oxide from a diesel engine, comprising the steps of: (a) impregnating a gamma-alumina support with an aqueous solution of the noble metal catalyst precursor and drying it repeatedly up to a preset number of times; (b) obtaining a noble metal/gamma-alumina catalyst by sintering at a predetermined temperature after step (a) is completed; (c) impregnating the noble metal/gamma-alumina catalyst with an aqueous solution of a metal oxide precursor and drying it repeatedly up to a preset number of times; and (d) preparing a passive nitrogen oxide adsorber composed of Ax-B/γ-alumina by sintering at a predetermined temperature after step (c) is completed, wherein the A is a noble metal catalyst, x is the mass percent of the noble metal catalyst, and the B is a metal.

### TECHNICAL FIELD

The present invention relates to a low-temperature nitrogen oxide adsorber based on a metal oxide-impregnated platinum/gamma-alumina catalyst and a method for preparing the same, and more particularly, to a passive nitrogen oxide adsorber capable of adsorbing nitrogen oxide in the cold-start condition of a diesel engine and a method for preparing the same.

### BACKGROUND ART

In diesel engines, as lean-burn engines are adopted, it is difficult to control emissions of exhaust gas components, especially nitrogen oxide.

Since the inflow of nitrogen oxide into the atmosphere is strictly regulated, automobiles are equipped with an exhaust gas purification system to reduce emissions by using appropriate catalysts.

Generally, in diesel engines, the emission of nitrogen oxide is controlled using selective catalytic reduction (hereinafter referred to as SCR).

At temperatures suitable for catalyst activity (generally above 200° C.), nitrogen oxide is reduced with high efficiency, but in the cold-start condition (generally below 200° C.), the ability to remove nitrogen oxide is significantly reduced.

The cold-start condition refers to the initial stage of starting and refers to a driving condition in which the temperature of the exhaust gas purification device is not sufficient.

It has been reported that the amount of nitrogen oxide emitted during the cold-start condition is greater than the amount of nitrogen oxide emitted during normal driving condition.

In order to control nitrogen oxide emitted in the cold-start condition, there is ongoing development of a catalyst that can effectively remove nitrogen oxide at low temperatures, specifically below 200° C.

FIG. 1 is a diagram showing the removal process of nitrogen oxide using a conventional passive nitrogen oxide adsorber (hereinafter referred to as PNA).

PNA system stores nitrogen oxide at temperatures below the SCR's operating range and desorbs nitrogen oxide when the temperature reaches the SCR's operating range.

A typical PNA uses a zeolite-based support impregnated with platinum or palladium noble metal catalyst.

In particular, catalysts formed by impregnating palladium on zeolite have high nitrogen oxide adsorption efficiency at low temperatures (generally 100° C.) and also desorbs at relatively low temperatures (generally 200 to 400° C.).

However, zeolite has a high affinity for moisture, and thus under humid conditions, its adsorption efficiency for nitrogen oxide is significantly reduced.

### DISCLOSURE

### Technical Problem

In order to solve the problems in the prior art described above, the present invention proposes a low-temperature nitrogen oxide adsorber based on a metal oxide-impregnated platinum/gamma-alumina catalyst that has excellent nitrogen oxide adsorption efficiency at low temperatures and can increase the low-temperature desorption ratio and a method for preparing the same.

### Technical Solution

In order to achieve the above-described objectives, according to an embodiment of the present invention, the present invention provides a method for preparing a PNA for removing nitrogen oxide from a diesel engine, comprising the steps of: (a) impregnating a gamma-alumina support with an aqueous solution of the noble metal catalyst precursor and drying it repeatedly up to a preset number of times; (b) obtaining a noble metal/gamma-alumina catalyst by sintering at a predetermined temperature after step (a) is completed; (c) impregnating the noble metal/gamma-alumina catalyst with an aqueous solution of a metal oxide precursor and drying it repeatedly up to a preset number of times; and (d) preparing a PNA composed of Ax-B/gamma-alumina by sintering at a predetermined temperature after step (c) is completed, wherein the A is a noble metal catalyst, x is the mass percent of the noble metal catalyst, and the B is a metal.

The noble metal catalyst is one of platinum and palladium, and the aqueous solution of the noble metal catalyst precursor may be ((NH₄)₂PtCl₄) or (Pd(NO₃)₂·2H₂O).

The noble metal included in the noble metal/gamma-alumina catalyst by sintering in step (b) may range from 0.5 to 2 percent by weight relative to the mass of the noble metal/gamma-alumina catalyst.

The aqueous solution of the metal oxide precursor includes at least one of an aqueous solution of the copper oxide precursor and an aqueous solution of the cerium oxide precursor, and the aqueous solution of the copper oxide precursor may be copper nitrate hydrate (Cu(NO₃)₂·3H₂O) and the aqueous solution of the cerium oxide precursor may be one of cerium chloride (CeCl₃), cerium sulfate (Ce(SO₄)₂), and cerium nitrate hydrate (Ce(NO₃)₃·6H₂O).

The mole fraction of copper and cerium may range from 4:6 to 6:4.

The mass ratio of the metal oxide formed by sintering in step (d), relative to the gamma-alumina support, may range from 20:1 to 5:1.

According to another aspect of the present invention, a PNA prepared by the above method is provided.

### Advantageous Effects

According to the present invention, there is an advantage that by co-impregnating platinum/gamma-alumina catalyst with copper oxide and cerium oxide, the adsorption of nitrogen oxide at low temperatures can be promoted.

In addition, through the introduction of metal oxide according to the present invention, it is possible to maintain a desorption temperature range suitable for application of a PNA.

### DESCRIPTION OF DRAWINGS

FIG. 1 is a diagram illustrating the removal process of nitrogen oxide using a conventional PNA.

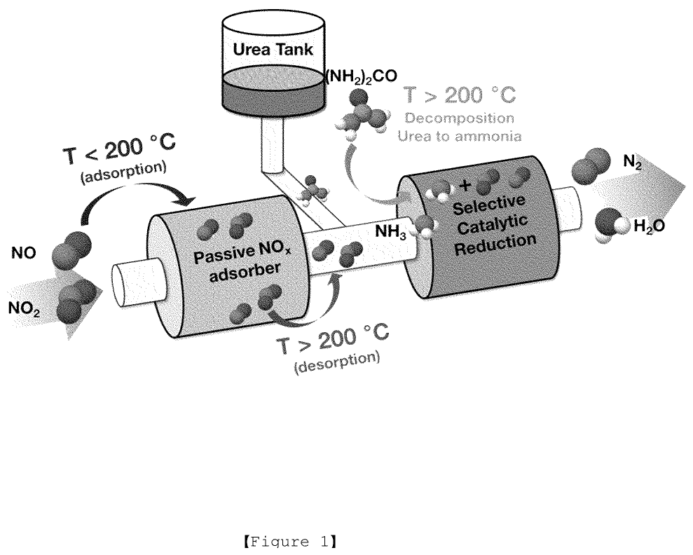

FIG. 2 is a diagram illustrating the synthesis process of a low-temperature nitrogen oxide adsorber based on a metal oxide-impregnated platinum/gamma-alumina catalyst according to this embodiment.

FIG. 3 is a diagram illustrating a comparison of the adsorption and desorption performance of the PNA.

FIG. 4 is a diagram illustrating a comparison of the nitrogen oxide storage efficiency (NSE) of the PNA of FIG. 3.

FIG. 5 is a diagram illustrating adsorption performance depending on the mole fraction of copper and cerium according to an embodiment of the present invention.

### BEST MODE

Since the present invention can make various changes and have various embodiments, specific embodiments will be illustrated in the drawings and described in detail.

However, this is not intended to limit the present invention to specific embodiments, and should be understood to include all changes, equivalents, and substitutes included in the spirit and technical scope of the present invention.

The present invention provides a new PNA material formed by impregnating metal oxides such as copper oxide and cerium oxide into a platinum/gamma-alumina-based catalyst.

The PNA to which the catalyst according to this embodiment is applied not only has excellent NSE at low temperatures, but also increases the nitrogen oxide desorption ratio at low temperatures of 400° C. or less.

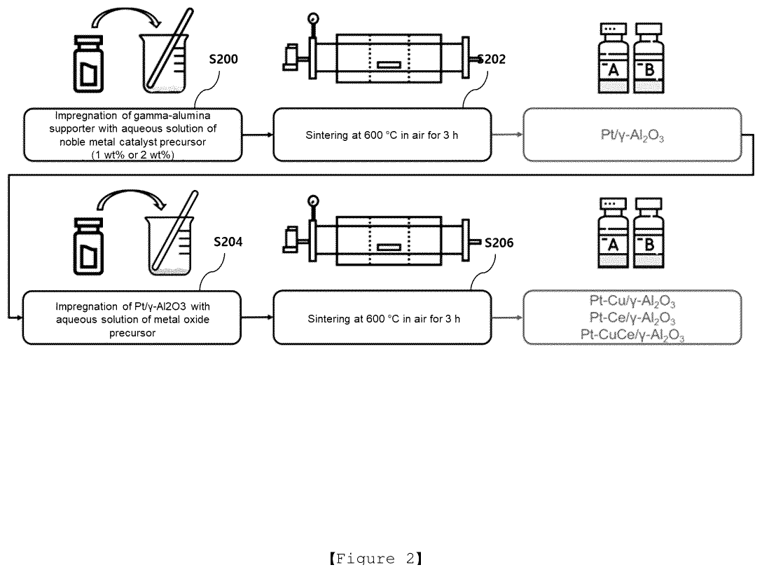

FIG. 2 is a diagram illustrating the synthesis process of a low-temperature nitrogen oxide adsorber based on a metal oxide-impregnated platinum/gamma-alumina catalyst according to this embodiment.

As shown in FIG. 2, the nitrogen oxide adsorber according to this embodiment is a PNA disposed at the front of the SCR, wherein it is manufactured by sequentially impregnating the gamma-alumina support with the noble metal catalyst precursor and the metal oxide precursor, rather than co-impregnating the noble metal catalyst precursor and the metal oxide precursor.

Referring to FIG. 2, first, a gamma-alumina support is impregnated with an aqueous solution of a noble metal catalyst precursor (step 200).

The specific surface area of the gamma-alumina support has a value of 200 m²/g, and the pore volume has a value of 0.9 cm³/g, which are variables that can affect the surface area characteristics and catalyst characteristics of the synthesized catalyst and adsorber.

According to this embodiment, the mass ratio of the gamma-alumina support and the noble metal catalyst precursor may be 200:1 to 20:1, and preferably 100:1 or 50:1.

Here, the noble metal catalyst impregnated into gamma-alumina may include platinum or palladium, the platinum catalyst precursor may be ((NH₄)₂PtCl₄), and the palladium catalyst precursor may be (Pd(NO₃)₂·2H₂O).

The noble metal catalyst can be adjusted to 0.5, 1, or 2% by weight relative to the mass of the total catalyst, and may be preferably 2% by weight.

The noble metal catalyst precursor is dissolved in an aqueous solution by a preset mass, and the total volume of the aqueous solution can be four times the pore volume of the gamma-alumina, which is the support.

When impregnating gamma-alumina with an aqueous solution of the noble metal catalyst precursor, only the volume corresponding to the pore volume of gamma-alumina is impregnated and dried in an oven at 110° C.

After repeating the above-described impregnation and drying process four times, the sintering is performed for 3 hours under air flow conditions at 600° C. (step 202).

The catalysts obtained through steps 200 to 202 are A1/gamma-alumina and A2/gamma-alumina. Here, A can be Pt or Pd, A1 means that the content of noble metal catalyst is 1 percent by weight, and A2 means 2 percent by weight.

Preferably, A may be platinum, and hereinafter, the description will focus on the fact that the catalyst obtained in step 202 is a platinum/gamma-alumina catalyst.

According to this embodiment, in order to improve the adsorption or desorption performance of the platinum/gamma-alumina catalyst, impregnation with an aqueous solution of metal oxide precursor is additionally performed (step 204).

The mass ratio of the platinum/gamma-alumina catalyst and the metal oxide precursor is a variable that can affect surface area characteristics and catalyst characteristics.

According to this embodiment, the metal oxide additionally impregnated into the platinum/gamma-alumina catalyst may be selected from copper and cerium oxide or a combination thereof.

The aqueous solution of cerium oxide precursor may include one of cerium chloride (CeCl₃), cerium sulfate (Ce(SO₄)₂), and cerium nitrate hydrate (Ce(NO₃)₃·6H₂O), and may preferably be cerium nitrate hydrate.

The aqueous solution of the copper oxide precursor may be copper nitrate hydrate (Cu(NO₃)₂·3H₂O).

The mass ratio of metal oxide additionally impregnated into platinum/gamma-alumina, relative to gamma-alumina, which is a support, may be 20:1 to 5:1, and preferably 10:1. When metal oxides of copper and cerium are impregnated simultaneously, the mass ratio of the two metal oxides may be 1:1.

The metal oxide precursor is dissolved in an aqueous solution by a preset mass. The total volume of the aqueous solution is six times the pore volume of gamma-alumina which is a support.

When impregnating platinum/gamma-alumina with an aqueous solution of metal oxide precursor, only the volume corresponding to the pore volume of gamma-alumina is impregnated and dried in an oven at 110° C. After repeating the above process six times, the sintering is performed for 3 hours under air flow conditions at 600° C. (step 206).

The PNA synthesized using copper oxide is named Pt1-Cu10/γ-alumina and Pt2-Cu10/γ-alumina.

The PNA synthesized using cerium oxide is named Pt1-Ce10/γ-alumina and Pt2-Ce10/γ-alumina, and the PNA synthesized using copper oxide and cerium oxide simultaneously is named Pt1-Cu5Ce5/γ-alumina and Pt2-Cu5Ce5/γ-alumina.

Below, the surface area characteristics of the PNA prepared as described above will be described.

Table 1 shows the BET surface area (m²/g) and pore volume of the PNA according to this embodiment.

TABLE 1

| | BET surface area (m²/g) | Pore volume (cm³/g) |
|---|---|---|
| Pt1/γ-Al₂O₃ | 144.2 | 0.81 |
| Pt2/γ-Al₂O₃ | 150.6 | 0.87 |
| Pt1—Cu10/γ-Al₂O₃ | 122.5 | 0.65 |
| Pt2—Cu10/γ-Al₂O₃ | 127.9 | 0.70 |
| Pt1—Ce10/γ-Al₂O₃ | 127.9 | 0.63 |
| Pt2—Ce10/γ-Al₂O₃ | 134.8 | 0.70 |
| Pt1—Cu5Ce5/γ-Al₂O₃ | 120.3 | 0.55 |
| Pt2—Cu5Ce5/γ-Al₂O₃ | 120.1 | 0.60 |

Referring to Table 1, it can be seen that when metal oxide was supported on the adsorber prepared in step 202, the surface area was further reduced, and the extent of reduction was smaller in adsorbers with a higher mass ratio of platinum.

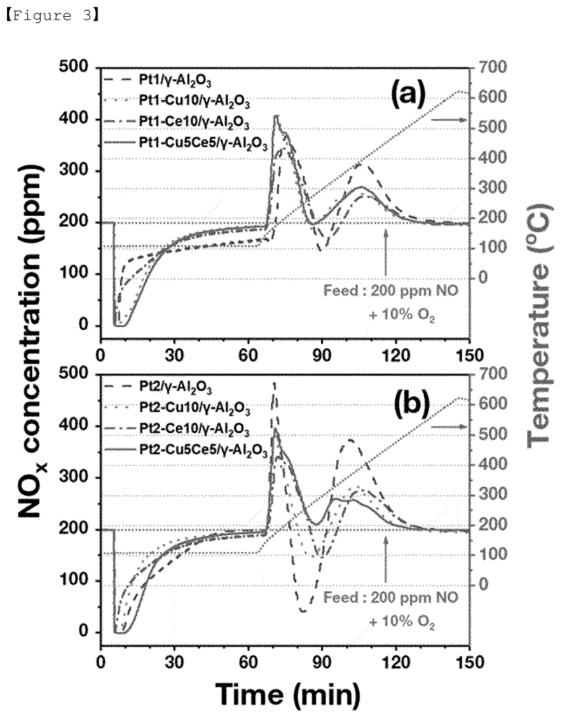

FIG. 3 compares the change in gas composition when a mixed gas of 200 ppm NO+10% O₂/N₂ composition was adsorbed for one hour at 100° C. and the temperature was raised to 600° C. while flowing gas of the same composition, in order to evaluate the nitrogen oxide adsorption and desorption performance.

FIG. 3a illustrates the change in gas composition through increasing temperature after adsorption of nitrogen monoxide in the presence of oxygen, in relation to the adsorbers based on platinum/gamma-alumina impregnated with 1% by weight of platinum and additionally impregnated with an aqueous solution of metal oxide precursor, and FIG. 3b illustrates the change in gas composition through increasing temperature after adsorption of nitrogen monoxide in the presence of oxygen, in relation to the adsorbers based on platinum/gamma-alumina impregnated with 2% by weight of platinum and additionally impregnated with an aqueous solution of metal oxide precursor.

First, comparing the nitrogen oxide adsorption section (5 to 65 minutes) at 100° C. in FIG. 3a, as the concentration of nitrogen oxide recovered quickly, it can be seen that in the case of Pt1/γ-A1₂O₃ and Pt1-Ce10/γ-A1₂O₃, almost no adsorption occurred.

On the other hand, in the case of Pt1-Cu10/γ-A1₂O₃ and Pt1-Cu5Ce5/γ-A1₂O₃, as the concentration of nitrogen oxide was slowly recovered, it can be seen that more nitrogen oxide was adsorbed compared to the previous two adsorbers. This is a result based on the excellent ability of copper to adsorb nitrogen oxide at low temperatures, and in particular, in the case of the adsorber co-impregnated with copper and cerium oxide, it can be expected that this is the result of the addition of cerium's ability to oxidize nitrogen monoxide.

Comparing the nitrogen oxide adsorption section (5 to 65 minutes) in FIG. 3b, it can be seen that among the four types of adsorber, Pt2-Cu5Ce5/γ-A1₂O₃ has the highest nitrogen oxide adsorption capacity. It can be seen that co-impregnation of copper and cerium improved the low-temperature nitrogen oxide adsorption performance both when the impregnation amount of the aqueous solution of platinum precursor was small and when it was large.

The comparison of the adsorption performance of PNA is a comparison of NSE (the difference between incoming nitrogen oxide and outgoing nitrogen oxide compared to incoming nitrogen oxide), and the formula for calculating NSE is as follows:

$${NO}_{x} storage effieciency = \frac{\int {NO}_{x inlet} - \int {NO}_{x outlet}}{\int {NO}_{x inlet}} \qquad [ Equation 1 ]$$

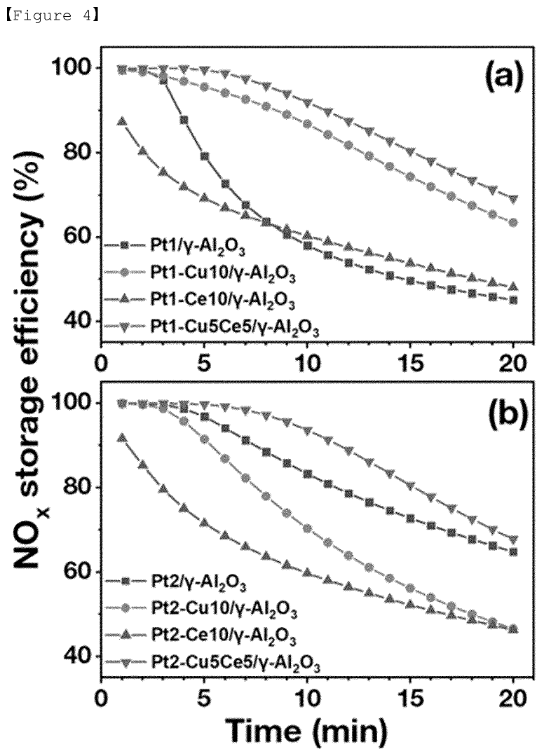

FIG. 4 is a diagram illustrating a comparison of the NSE of the PNA in the adsorption section (5 minutes to 65 minutes) of FIG. 3 using the calculation method of Equation 1.

Referring to FIG. 4, it can be seen that regardless of the amount of platinum impregnated, the adsorber co-impregnated with an aqueous solution of copper and cerium precursors shows the highest NSE. In particular, it showed that the NSE exceeded 90% for more than 10 minutes.

Afterwards, when comparing the nitrogen oxide desorption section (65 minutes to 150 minutes), it can be seen that in the case of all adsorbers, desorption occurred twice at low temperature (around 200° C.) and high temperature (around 400° C.). Since the PNA must desorb smoothly within the operating range of the SCR, the higher the desorption ratio at low temperature, the more advantageous. Accordingly, the ratio of nitrogen oxide desorption at a temperature of 400° C. or lower for each adsorber was calculated, and the results are shown in Table 2.

TABLE 2

| | Ratio of nitrogen oxide desorbed at |
|---|---|
| | 400° C. or lower (%) |
| Pt1/γ-Al₂O₃ | 74.4 |
| Pt2/γ-Al₂O₃ | 75.2 |
| Pt1—Cu10/γ-Al₂O₃ | 88.9 |
| Pt2—Cu10/γ-Al₂O₃ | 89.4 |
| Pt1—Ce10/γ-Al₂O₃ | 85.4 |
| Pt2—Ce10/γ-Al₂O₃ | 77.4 |
| Pt1—Cu5Ce5/γ-Al₂O₃ | 88.4 |
| Pt2—Cu5Ce5/γ-Al₂O₃ | 92.0 |

According to Table 2, when co-impregnated with an aqueous solution of copper and cerium precursor, it is shown that the ratio of nitrogen oxide desorbed at 400° C. or lower is higher compared to other adsorbers. In particular, it can be seen that Pt2-Cu5Ce5/γ-A1₂O₃ desorbs more than 90% of nitrogen oxide at 400° C. or lower. Therefore, it can be confirmed that among adsorbers based on platinum/gamma-alumina containing metal oxide, the Pt2-Cu5Ce5/γ-A1₂O₃ adsorber has the highest NSE and the highest low-temperature desorption ratio.

According to a preferred embodiment of the present invention, in the nitrogen oxide adsorber based on platinum/gamma-alumina containing metal oxide, the mole fraction of copper and cerium may be 4:6 to 6:4, and more preferably 5:5.

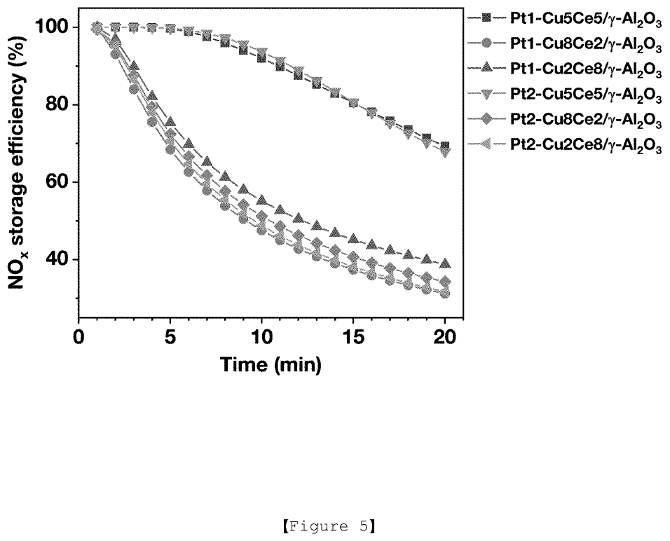

FIG. 5 is a diagram illustrating adsorption performance depending on the mole fraction of copper and cerium according to an embodiment of the present invention.

As shown in FIG. 5, it can be confirmed that the highest NSE is achieved when copper and cerium have a symmetrical mole fraction such as 5:5 rather than when copper and cerium have an asymmetrical mole fraction such as 2:8 to 8:2.

The above-described embodiments of the present invention have been disclosed for illustrative purposes, and a person skilled in the art with ordinary knowledge of the present invention will be able to make various modifications, changes, and additions within the spirit and scope of the present invention, and such modifications, changes and additions should be regarded as falling within the scope of the patent claims below.

1. A method for preparing a passive nitrogen oxide adsorber to remove nitrogen oxide from a diesel engine, comprising the steps of:
(a) impregnating a gamma-alumina support with an aqueous solution of the noble metal catalyst precursor and drying it repeatedly up to a preset number of times;
(b) obtaining a noble metal/gamma-alumina catalyst by sintering at a predetermined temperature after step (a) is completed;
(c) impregnating the noble metal/gamma-alumina catalyst with an aqueous solution of a metal oxide precursor and drying it repeatedly up to a preset number of times; and
(d) manufacturing a passive nitrogen oxide adsorber composed of Ax-B/γ-alumina by sintering at a predetermined temperature after step (c) is completed,
wherein the A is a noble metal catalyst, x is the mass percent of the noble metal catalyst, and the B is a metal.

2. The method for preparing the passive nitrogen oxide adsorber according to claim 1, wherein the noble metal catalyst is one of platinum and palladium, and the aqueous solution of the noble metal catalyst precursor is ((NH₄)₂PtCl₄) or (Pd(NO₃)₂·2H₂O).

3. The method for preparing the passive nitrogen oxide adsorber according to claim 2, wherein the noble metal included in the noble metal/gamma-alumina catalyst by sintering in step (b) has a range of 0.5 to 2 percent by weight relative to the mass of the noble metal/gamma-alumina catalyst.

4. The method for preparing the passive nitrogen oxide adsorber according to claim 1, wherein the aqueous solution of the metal oxide precursor includes at least one of an aqueous solution of the copper oxide precursor and an aqueous solution of the cerium oxide precursor, the aqueous solution of the copper oxide precursor is copper nitrate hydrate (Cu(NO₃)₂·3H₂O), and the aqueous solution of the cerium oxide precursor is one of cerium chloride (CeCl₃), cerium sulfate (Ce(SO₄)₂), and cerium nitrate hydrate (Ce(NO₃)₃·6H₂O).

5. The method for preparing the passive nitrogen oxide adsorber according to claim 4, wherein the mole fraction of copper and cerium ranges from 4:6 to 6:4.

6. The method for preparing the passive nitrogen oxide adsorber according to claim 1, wherein the mass ratio of the metal oxide formed by sintering in step (d), relative to the gamma-alumina support, ranges from 20:1 to 5:1.

7. A passive nitrogen oxide adsorber prepared by the method according to claim 1.
